(19) United States
(12) Patent Application Publication
(10) Pub. No.: US 2007/0265738 A1
(43) Pub. Date: Nov. 15, 2007

(54) Seat system adapted for motor vehicle

(75) Inventor: Shinji Saito, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/542,627

(22) Filed: Oct. 4, 2006

(30) Foreign Application Priority Data
Oct. 6, 2005 (JP) 2005-293842

(51) Int. Cl. G06F 17/00; B60N 2/02; H04L 9/00

(52) U.S. Cl. 701/2; 297/217.1; 380/277

(57) ABSTRACT

A seat system, adapted for a motor vehicle, includes a portable device taken along with a user for sending at least identification information, an on-vehicle front seat, an on-vehicle actuator for actuating the front seat, a keyless control unit and a seat control unit. The keyless control unit communicates with the portable device to lock and unlock door locks when the identification information is authorized, and the seat control unit actuates the actuator to perform a walk-in function for changing a position state of the front seat for a passenger to easily get in a rear seat side compartment according to an operation of the portable device when the authorization is made.

### BACKGROUND OF THE INVENTION

1. Field of the Invention

The present invention belongs to technical field of a seat system adapted for a motor vehicle that has a walk-in function of enabling at least a driver's seat or a front passenger's seat to change a state thereof for easy getting-in of a passenger when the passenger gets in a rear seat side compartment of a motor vehicle.

2. Description of the Related Art

A Conventional seat system adapted for a motor vehicle is disclosed in Japanese Utility Model No. 2510152. This conventional seat system adjusts a position state of a seat according to a driver identifying signal of an infrared data communication between a transmitter and a keyless control unit related with a seat control unit when a door is locked and unlocked.

The above known conventional seat system, however, encounters a problem in that only a driver's seat can be adjusted by moving it and changing its position state to an optimum position for a driver according to a switch operation. Consequently, when a passenger gets in to sit on a rear seat of a motor vehicle such as a two door vehicle, a front seat interferes his or her smooth getting-in. It takes time to enter a rear-seat side compartment, which causes the passenger to wait in a state where the door is kept being opened. This wets the driver and an interior of the motor vehicle in a rainy day. In addition, in order to support the passenger to get in the rear-seat side compartment, the driver feels troublesome, because the driver needs to press a walk-in switch after he or she moves toward a front passenger's seat side, or gets in a driver's seat.

### SUMMARY OF THE INVENTION

The present invention is made in a view of the above-mentioned problem, and its object is to provide a seat system adapted for a motor vehicle which overcomes the foregoing drawbacks and can allow a passenger to get in a rear seat side compartment in a short time, and thereby decreasing driver's troublesome action.

In order to achieve the above-mentioned object, a seat system, adapted for a motor vehicle, of the present invention includes a portable device that is taken along with a user and is capable of sending at least identification information, a keyless control unit that is installed on a motor vehicle to communicate with the portable device for locking and unlocking door locks when authorization is made based on the identification information, and a seat control unit that is installed on the motor vehicle to actuate an actuator to perform a walk-in function where a position state of the front seat is changed so that a passenger can easily get in a rear seat side compartment.

Incidentally, “a walk-in function” in the present invention denotes that a front seat can be moved forward, and/or a seat back portion of the front seat can be inclined forward so as to enable a passenger to smoothly get in the rear-seat side compartment when the passenger wants to take the rear seat. Therefore, in the seat system of the present invention, the passenger can avoid being drenched by getting in the rear-seat side compartment in a short time. In addition, the driver can easily perform the walk-in function, thereby feeling little troublesome when a passenger has his or her luggage.

### BRIEF DESCRIPTION OF THE DRAWINGS

The objects, features and advantages of the present invention will become apparent as the description proceeds when taken in conjunction with the accompanying drawings, in which:

FIG. 1 is a diagram showing main construction parts including a portable device and vehicle side parts used in a seat system adapted for a motor vehicle of a first embodiment according to the present invention;

FIG. 2 is a schematic view showing a seat that can perform a walk-in function;

FIG. 3 is a flow chart of a door-lock process executed by a keyless control unit and a process of a walk-in action executed by a seat control unit, where the control units are installed on a vehicle side to constitute the seat system of the first embodiment;

FIG. 4 is a flow chart of a door-lock process executed by a keyless control unit and a process of a walk-in action executed by a seat control unit, where the control units are installed on a vehicle side to constitute a seat system, adapted for a motor vehicle, of a second embodiment according to the present invention;

FIG. 5 is a diagram showing main construction parts of a portable device and vehicle side parts used in a seat system, adapted for a motor vehicle, of a third embodiment according to the present invention; and

FIG. 6 is a diagram showing main construction parts of a portable device and vehicle side parts used in a seat system, adapted for a motor vehicle, of a fourth embodiment according to the present invention.

### DETAILED DESCRIPTION OF THE PREFERRED EMBODIMENTS

Throughout the following detailed description, similar reference characters and numbers refer to similar elements in all figures of the drawings, and accordingly their descriptions are omitted for eliminating duplication.

### A First Embodiment

A first embodiment of the present invention will be described with respect to the accompanying drawings.

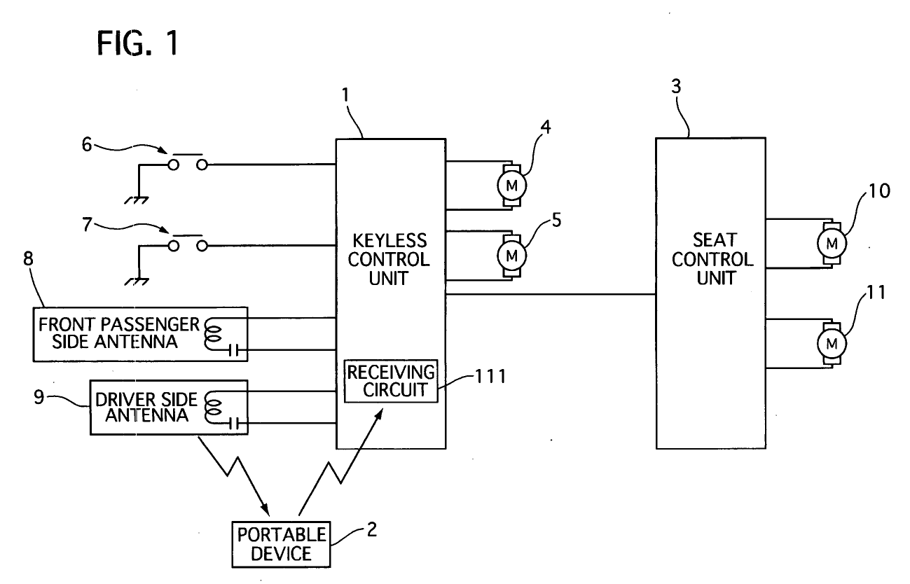

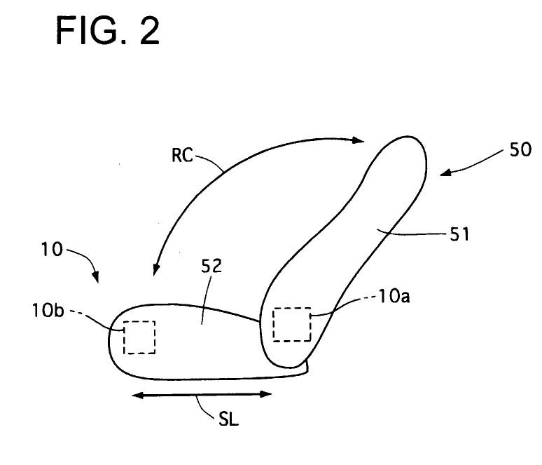

As shown in FIG. 1, a seat system, adapted for a motor vehicle, of the first embodiment includes a portable device a driver can take along, a driver's seat shown in FIG. 2 and a not-shown front passenger's seat each provided on a vehicle side, a not shown rear seat, a keyless entry system for controlling lock/unlock of doors, and a seat control system.

Incidentally, in this embodiment, the motor vehicle is a two door vehicle, and the keyless entry system uses most parts of a conventional keyless entry system to decrease its total manufacturing costs.

The keyless entry system has a keyless control unit 1, a driver's-seat side door actuator 4 and a front-passenger's-seat side door actuator 5, where the actuators 4 and 5 are controlled by the keyless control unit 1. A driver's seat 50 and a front passenger's seat correspond to a front seat of the present invention.

The driver's-seat side door actuator 4 is controlled by the keyless control unit 1 to lock and unlock the driver's seat side door. The front passenger's-seat side door actuator 5 is controlled by the keyless control unit 1 to lock and unlock the front passenger's seat side door.

The keyless control unit 1 is equipped with a receiving circuit 111, and is electrically connected with a front passenger side antenna 8 and a driver side antenna 9 so that a wireless communication can be implemented between the receiving circuit 111 and the portable device 2 via the front passenger side antenna 8 or the driver side antenna 9. Incidentally, the driver side antenna 8 sends and receives electric wave at a driver's seat side between the driver side antenna 8 and the portable device 2. The front passenger side antenna 9 sends and receives electric wave at a front passenger's seat side between the front passenger side antenna 9 and the portable device 2.

The keyless control unit 1 is electrically connected with a driver's-seat request switch 6 and a front-passenger's-seat request switch 7. The driver's seat request switch 6 is arranged on a door knob of the driver's seat side door or at the periphery of the door knob, so as to be operated on the eve of a door-opening operation of a passenger. The front-passenger's-seat request switch 7 is arranged on a door knob of the front-passenger's seat side door or at the periphery of the door knob, so as to be operated on the eve of a door-operating operation of the passenger.

The portable device 2 has identification (ID) data set in advance, as identification information for identifying individual motor vehicles. The portable device 2 and the keyless control device 1 are constructed in such a way that the wireless communication is made between the portable device 2 and the keyless control device 1 so that the keyless control device 1 can perform an authentication process of the ID data obtained from the portable device 2, when the driver's-seat request switch 6 or the front-passenger's-seat request switch 7 is operated in an area where the portable device 2 is within a predetermined distance from the motor vehicle.

When the ID is authorized, the keyless control unit 1 controls the driver's-seat side door actuator 4 or the front-passenger's-seat side door actuator 5 to be actuated to unlock the door according to a signal outputted from the driver's-seat request switch 6 or the front-passenger's-seat request switch 7, respectively. In addition, when the portable device 2 is located out of the predetermined distance area and the communication is in an uncontrollable state between the portable device 2 and the keyless control unit 1, the keyless control unit 1 controls the driver's-seat side door actuator 4 or the front-passenger's-seat side door actuator 5 to be actuated to lock the doors. In this control, the keyless control unit 1 outputs signals, concerning an authentication state of the portable device 2, and states of the driver's-seat request switch 6 and the front-passenger's-seat request switch 7, to a seat control unit 3.

The portable device 2 is taken along mainly with the driver, and receives search electric wave and request information from the keyless control unit 1 to send its ID data to the keyless control unit 1.

On the other hand, the seat system has the seat control unit 3, which uses a part of functions of the keyless entry system so as to change position states of the driver's seat 50 and the front passenger's seat.

The seat control unit 3 is electrically connected with the keyless control unit 1, a driver's-seat motor 10, and a front-passenger's-seat motor 11, so as to control the driver's-seat motor 10 and the front-passenger's-seat motor 11 based on a signal outputted from the keyless control unit 1.

Specifically, the seat control unit 3 is constructed in such way that, when it receives information on a communication state with the portable device 2 and on the ID authorization from the keyless control unit 1, it controls the driver's-seat motor 10 and the front-passenger's-seat motor 11 to drive to provide a walk-in action for performing a walk-in function of changing the position state of the driver's seat or the front passenger's seat so that a passenger can smoothly get in a rear-seat side compartment. Incidentally, the walk-in actuation is set to include a return actuation for returning the position state of the seat to a normal seat position state after a predetermined time is detected by a timer to have passed from a manual operation of an inner switch arranged at the inner side of the motor vehicle or from start of the walk-in actuation.

Although only one driver's-seat motor 10 is illustrated to be simplified in FIG. 1, it actually has a reclining motor 10a and a seat slide motor 10b. They are constructed in such a way that, when the seat control unit 3 outputs a drive command signal, the reclining motor 10a reclines a seat back portion 51 of the driver's seat 50 forward in a reclining direction indicated by an arrow RC in FIG. 2, and the seat slide motor 10b provided under a seat cushion portion 52 moves the entire of the driver's seat 50 forward as indicated by an arrow SL. When the reclining motor 10a and the seat slide motor 10b are controlled in a direction opposite to an actuation direction in the walk-in function, the driver's seat can be returned to the normal seat position state.

Incidentally, the front-passenger'-seat motor 11 is constructed similarly to the driver's-seat motor 10, thereby providing actuation of walk-in function and return actuation of the front-passenger'-seat motor 11.

The operation of the seat system of the first embodiment will be described with the operation of the keyless entry system related thereto.

First, a door-lock control process executed by the keyless control unit 1 and a walk-in actuation control process executed by the seat control unit 3 will be described.

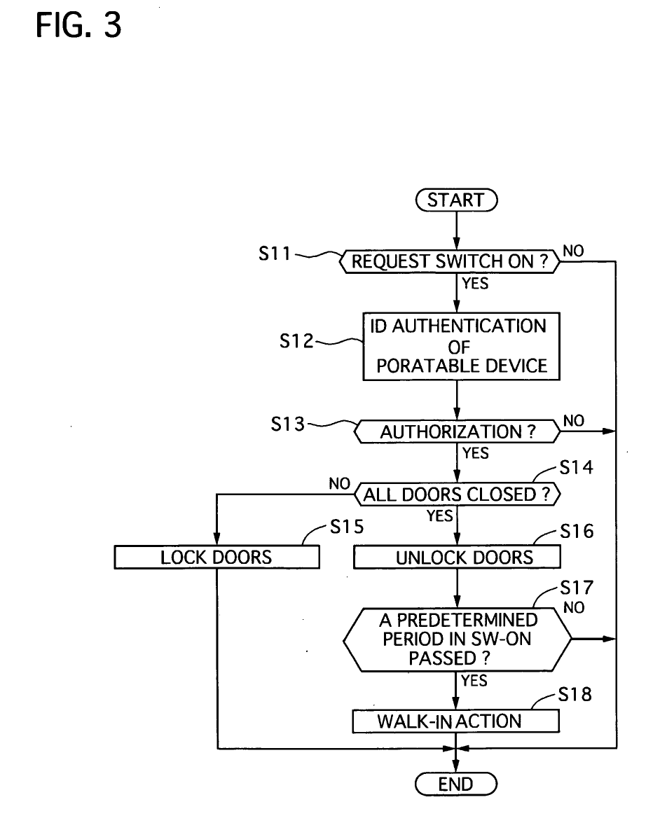

A flow chart of these control process are shown in FIG. 3.

At step S11, the keyless control unit 1 judges, based on a request signal outputted from the driver's-seat request switch 6 or the front-passenger's-seat request switch 7, whether or not a request signal is ON. If YES, the flow goes to step S12, while if NO, the process is ended.

At the step S12, the keyless control unit 1 makes the communication with one of the driver side antenna 8 and the front passenger side antenna 9 via the receiving circuit 111 to receive the ID information outputted from the portable device 2 and authenticates the ID data, and then the flow goes to step S13.

At the step S13, the keyless control unit 1 judges the result of the ID authentication of the portable device 2. If the ID is authorized, the flow goes to step S14, while if the ID is not authorized, the process is ended.

At the step S14, the keyless control unit 1 judges, based on door signals of not-shown door sensors, whether or not all of the doors are closed. If YES, the flow goes to step S16, while if No, the flow goes to step S15.

At the step S15, the keyless control unit 1 controls the driver's-seat side door actuator 4 and the front-passenger's-seat side actuator 5 to be actuated to lock not-shown door locks of all the doors.

At the step S16, the keyless control unit 1 controls driver's-seat side door actuator 4 and the front-passenger's-seat side actuator 5 to be actuated to unlock the door locks of all the doors, and then the flow goes to step S17.

At the step S17, the seat control unit 3 judges, based on the signals outputted from the keyless control unit 1, whether or not the request switch is kept to be ON beyond the predetermined time. If YES, the flow goes to step S18, while if NO, the process is ended.

At the step S18, the seat control unit 3 controls the driver's-seat motor 10 and/or the front-passenger's-seat motor 11 to be actuated to provide the walk-in actuation for changing the position state(s) of the driver's seat 50 and/or the front passenger's seat.

In this embodiment, the walk-in actuation is performed as follows in connection with the door locks.

In the seat system of the motor vehicle of the first embodiment, all of the doors are unlocked, and both of the driver's seat 50 and the front passenger's seat are moved in the walk-in actuation, when authorization is obtained at either a left door side or a right door side via the front-passenger side antenna 8 or via the driver side antenna 9. That is, when a user of the motor vehicle, such as the driver, approaches the motor vehicle with the portable device 2 to be within the predetermined distance area, the receiving circuit 111 of the keyless control unit 1 becomes to communicate with the portable device 111 at least via either of the front-passenger side antenna 8 or the driver side antenna 9.

In this state, when the user having the portable device 2 presses one of the driver's-seat request switch 6 and the front passenger's-seat request switch 7, the portable device 2 sends the ID data thereof and the receiving circuit 111 receives it, and then the keyless control unit 1 executes the authentication process based on it. These processes correspond to the step S11 and the step S12 in FIG. 3. When it is authorized, the keyless control unit 1 controls the driver's-seat side door actuator 4 and the front-passenger's-seat side door actuator 5 to drive and unlock the both doors. These processes correspond to the step S13 and the step S14 in FIG. 3.

When the user wants to implement the walk-in function, the driver needs to keep pressing the driver's-seat request switch 6 or the front-passenger's-seat request switch 7, which has been operated, to maintain an ON state. The seat control unit 3 judges a demand operation for the walk-in function when the request switch 6 or 7 is kept to be the ON state beyond a predetermined time has passed. This process corresponds to the step S18 in FIG. 3. That is, the user can input by pressing the request switch for a long time so as to perform the walk-in function. Therefore, when the user does not to perform the walk-in function, he or she may press the driver's-seat request switch 6 or the front-passenger's-seat request switch 7 to be in the ON state for a short time.

When the walk-in function is performed, the seat control unit 3 controls the driver's-seat motor 10 and the front-passenger's-seat motor 11 to drive, thereby reclining the seat backs of the driver's seat 50 and the front passenger's seat forward and moving the entire seats forward. These position state changes of the seats ensure large spaces between the opened driver's-seat side door and the position-state changed driver's seat and between the opened front-passenger's-seat side door and the position-state changed front-passenger's seat. This enables a passenger or passengers to get in the rear seat side compartment through the space and/or the spaces.

The seat system, adapted for the motor vehicle, of the first embodiment can obtain the effects listed below.

(1) The seat system has the portable device 2 that is taken along with the user and is capable of sending at least the ID information, the keyless control unit 1 for locking or unlocking the door keys when the ID is authorized, the seat control unit 3 for actuating the walk-in function where at least the position state of the front seat can be changed so that a passenger can smoothly get in the rear seat side compartment after the authorization, and the driver's seat motor 10 and the front-passenger's-seat motor 11 both for changing the position state of the front seat. This enables the passenger to smoothly get in the rear seat side compartment in a short time by an operation similar to that of unlocking the door lock, thereby avoiding the passenger to be drenched in a rainy day when he or she waits and enters the motor vehicle.

(2) In addition, the walk-in actuation can be obtained by pressing the request switch for a long time, similarly to the operation of unlocking the door locks. This does not require another special operation, removing a troublesome feeling of the user.

In motor vehicles, the effects of the first embodiment, as described above, does not relates directly to performances, such as a running performance, of the motor vehicles, but they are very important to the users because he or she repeats the walk-in function many times and estimates the motor vehicle based thereon.

In addition, in the seat system of the first embodiment, a part of processes carried out by the normal keyless system is used for performing processes, such as a process of judging whether or not the walk-in function is to be performed, and a communication process. This can greatly decrease its manufacturing costs.

Incidentally, in the first embodiment, there are provided the driver's-seat side request switch 6 and the front-passenger's-seat side request switch 7, either of which can perform the walk-in function, while the front-passenger's-seat side request switch 7 may be removed and only the driver's seat side request switch 6 may be provided to perform the walk-in function. In this case, the operation of unlocking the door lock and the operation of actuating the walk-in function can be performed by only one switch. This allows only the driver to operate the switch to perform the door-lock function and the walk-in function without a troublesome feeling, decreasing operation burden of other passenger(s).

In a case of a motor vehicle where a passenger can get in the rear seat side compartment only from the front-passenger's-seat side, the driver's-seat motor 10 is removed and only the front-passenger's-seat motor 11 is provided to perform the walk-in function only at the front-passenger's-seat side.

### A Second Embodiment

A seat system, adapted for a motor vehicle, of a second embodiment according to the present invention is an example in which a first operation causes a walk-in function of a driver's seat to be performed, and next operation causes the walk-in function of a front passenger's seat. In other words, this is the example in which the seat system judges, based on the operation of a user and a state of a motor vehicle, which of the walk-in functions of the driver's seat and the passenger's seat is demanded.

The seat system of the second embodiment is constructed similarly to that of the first embodiment, and its drawings and descriptions are omitted. The seat system of the second embodiment is different from that of the first embodiment, only in a process executed by a seat control unit.

The operation of the seat system of the second embodiment will be described.

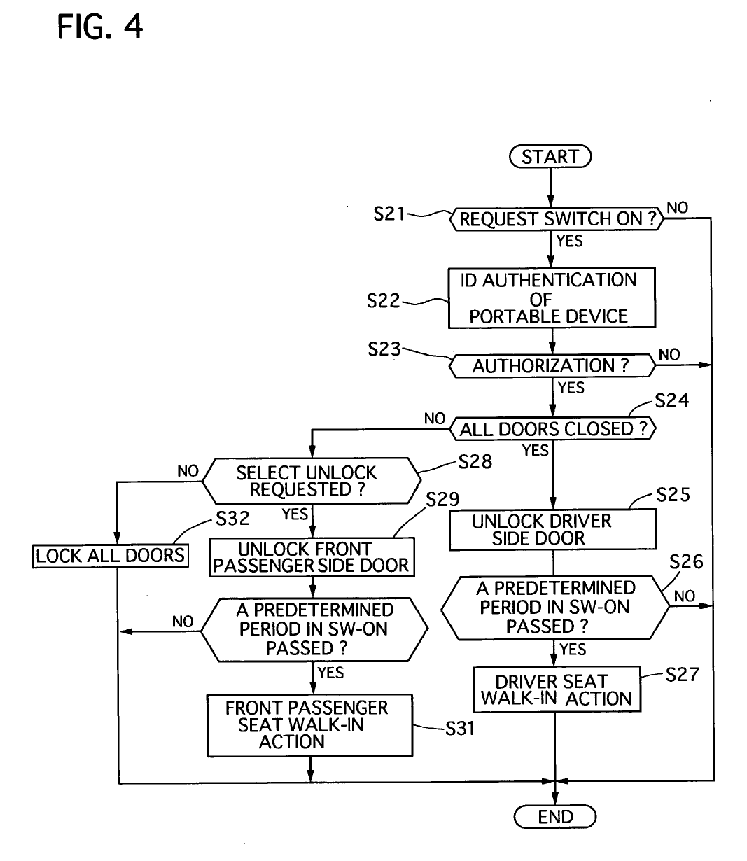

FIG. 4 shows a flow chart of a door-lock actuation process executed by a keyless control unit 1 of a keyless entry system adapted for a motor vehicle and a walk-in actuation process executed by a seat control unit 3.

At step S21, the keyless control unit 1 judges, based on a request signal outputted from a request switch, whether or not a request signal is ON. If YES, the flow goes to step S22, while if NO, the process is ended.

At the step S22, the keyless control unit 1 makes the communication with a portable device 2 to receive the ID information outputted from the portable device 2 and authenticates the ID data, and then the flow goes to step S23.

At the step S23, the keyless control unit 1 judges the result of the ID authentication of the portable device 2. If the ID is authorized, the flow goes to step S24, while if the ID is not authorized, the process is ended.

At the step S24, the keyless control unit 1 judges whether or not all of the doors are closed. If YES, the flow goes to step S25, while if No, the flow goes to step S28.

At the step S25, the keyless control unit 1 controls a driver's-seat side door actuator 4 to be actuated to lock a not-shown door lock of a not-shown driver's-seat side door, and then the flow goes to step S26.

At the step S26, the seat control unit 3 judges whether or not the request switch is kept to be ON beyond a predetermined time. If YES, the flow goes to step S27, while if NO, the process is ended.

At the step S26, the seat control unit 3 controls a driver's-seat motor 10 to be actuated to perform the walk-in function of the driver's seat, and then the process is ended.

At the step S28, the seat control unit 3 judges whether or not select unlock is demanded. If YES, the flow goes to step S29, while if NO, the flow goes to step S32. Incidentally, hereinafter, “select unlock” denotes that the driver's-seat side door is unlocked at first and then a front-passenger's-seat side door is unlocked when the request switch is operated twice in a predetermined time in a state of all doors closed.

At the step S29, the keyless control unit 1 controls a front-passenger's-seat actuator 5 to be actuated to unlock the front-passenger's-seat side door, and then the flow goes to step S30.

At the step S30, the seat control unit 3 judges whether or not the request switch is kept to be ON beyond a predetermined time. If YES, the flow goes to step S31, while if NO, the process is ended.

At the step S31, the seat control unit 3 controls the front-passenger's-seat motor 11 to be actuated to perform the walk-in function of the front passenger's seat, and the process is ended.

On the other hand, at the step S32, the keyless control unit 1 controls to lock all of the doors.

Next, the walk-in actuation, provided in connection with the select unlock, of the seat system of the second embodiment will be described.

The seat control unit 3 judges a demand of the select unlock when a driver's-seat side request switch 6 or a front-passenger's-seat side request switch 7 is operated twice to input its signals to the seat control unit 3 in the predetermined time. That is, when the request switch is operated twice in the predetermined time in a state where the door lock of the driver's-seat side door is unlocked, the door lock of the front-passenger's-seat side door. When the user wants to unlock the driver's-seat side door or the front-passenger's-seat side door, long-time pressing of the request switch causes performing of the walk-in function at once.

For example, in a case of an operation of the driver's-seat side request switch 6, one short-time input causes only the unlock of the door lock of the driver's-seat side door, one long-time input causes the unlock of the door lock of the driver's-seat side door, two shot-time inputs cause only the unlock of the door locks of the driver's-seat side door and the front-passenger's-seat side door, and two long-time inputs cause the walk-in actuations of the driver's seat and the front passenger's seat in addition to the unlock of the door locks of the driver's-seat side door and the front-passenger's-seat side door.

Thus, the user can select from a driver's-seat side door actuator 4, a front-passenger's side door actuator 5, the driver's-seat motor 10, and the front-passenger's-seat motor 11 to be actuated, without increasing the number of switches. This enables the user to easily operate without a troublesome feeling.

Thus, in the seat system of the second embodiment, the keyless control unit 1 and the seat control unit 3 checks a state of the driver's-seat side door, as a state of a motor vehicle, when the second operation signal is inputted, and controls the actuators and the motors. Therefore, the actuation of the driver's seat is set to have sequencing prior to that of the front passenger's seat, so as to control the actuators and the motors of the driver's seat side and the front passenger's seat side by a simple operation.

He seat system of the second embodiment has the following effect in addition to the effects (1) and (2) of the first embodiment.

In the seat system of the second embodiment, the door(s) can be locked and unlocked by any one of operations of the driver's-seat side request switch 6 and the front-passenger's-seat side request switch 7, and in particular the seat system of the second embodiment can obtain the following effect by using the driver's-seat side request switch 6.

(3) In the seat system of the second embodiment, the driver's-seat side request switch 6 is arranged at the driver's seat side for executing an authentication process, and the keyless control unit 1 judges which of the driver's seat and the front passenger's seat is actuated to perform the walk-in function, and the seat control unit 3 performs the walk-in function of the seat which the keyless control unit 1 judges when ID information, obtained by the operation of the driver's-seat side request switch 6, is authorized. Therefore, a plurality of actuation patterns can be performed by a simple operation, so that the driver does not feel troublesome in its operation and a passenger can smoothly get in a rear seat side compartment in a short time.

### A Third Embodiment

A set system of a third embodiment is an example in which a user can selectively perform a walk-in function of a driver's seat or the walk-in function of a front passenger's seat.

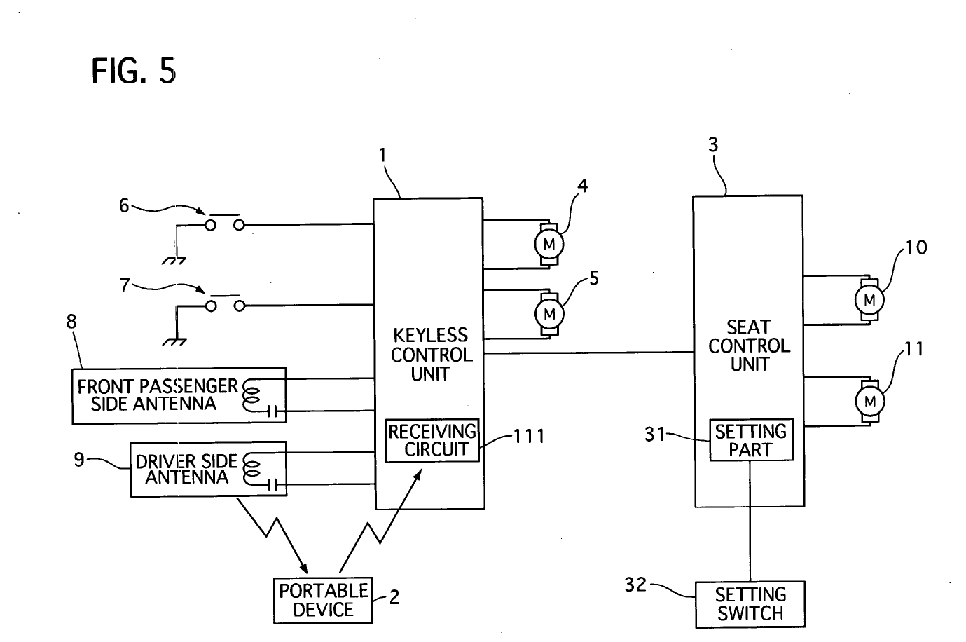

A construction of the seat system of the third embodiment will be described with reference to the accompanying drawing of FIG. 5.

In the seat system of the third embodiment, a seat control unit 3 is provided with a setting part 31 for setting which of the walk-in function is performed between the driver's seat and the front passenger's seat, and a setting switch 32 is provided inside of a motor vehicle so as to be manually operated by a user, so that a selection, of the walk-in function of the driver's seat and the front passenger's seat, is preset by the operation of the setting switch 32. The other parts are similar to those of the first embodiment, and accordingly their descriptions are omitted.

The operation of the seat system of the third embodiment will be described.

First, a setting operation, of selecting the walk-in functions of the driver's seat and the front passenger's seat, will be described.

In the seat system of the third embodiment, the seat system is constructed so that the user can set one, to be actuated, of the walk-in functions of the driver's seat and the front passenger's seat in advance according a state of use. When the walk-in actuation is demanded, the seat control unit 3 controls the seat set by the setting part 31 to perform the walk-in actuation.

The seat system of the third embodiment has the following effect in addition to the effects (1) and (2) of the first embodiment.

(4) In the seat system of the third embodiment, the driver's-seat side request switch 6 is provided at the driver's seat side to execute the authentication process, and the setting part 31 is provided to set the seat to be actuated to perform the walk-in function of the set one of the driver's seat and the front passenger's seat. The seat controller 3 actuates the seat set by the setting part 31 to perform the walk-in function when the ID information obtained by the operation of the driver's-seat side request switch 1. Therefore, it can improve its user friendliness, and enables the user to perform the walk-in function of the seat the user wants to move by a simple operation. This is useful, for example, in a case where the driver knows that a person to be seated on the front passenger's seat wants to place his or her luggage on a rear seat.

### A Fourth Embodiment

A seat system of a fourth embodiment is an example in which a request switch is arranged on a portable device.

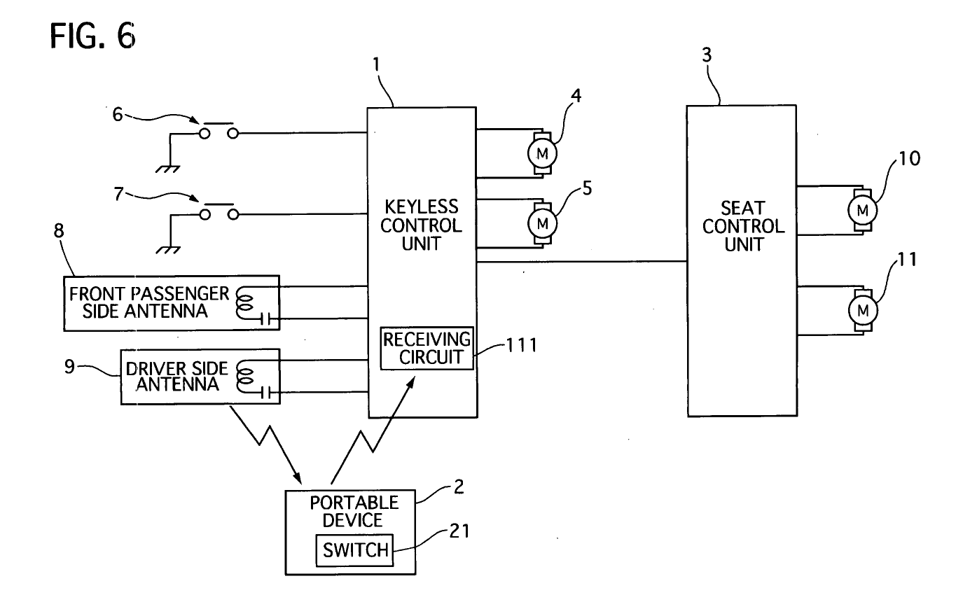

A construction of the seat system of the fourth embodiment will be described with reference to the accompanying drawing of FIG. 6.

In the seat system of the fourth embodiment, a portable device 2 is provided thereon with portable-device side request switch 21. A driver's-seat side request switch 6 and a front-passenger's-seat side request switch 7 may be added or may be removed in the fourth embodiment. The other parts of the fourth embodiment are similar to those of the first embodiment, and accordingly their descriptions are omitted.

The operation of the seat system of the fourth embodiment will be described.

A keyless control unit 1 and a seat control unit 3 executes a process shown in FIG. 3 when the portable-device side request switch 21 is operated. Therefore, a user can easily operate the portable-device side request switch 21, holding his or her luggage and child. That is, the user can control lock and unlock of door locks and a walk-in actuation of a seat without touching a motor vehicle side.

The seat system of the fourth embodiment has the following effect in addition to the effects (1) and (2) of the first embodiment.

(5) In the seat system of the fourth embodiment, the portable device 2 is provided with the portable-device side request switch 21 to execute an ID authentication process, and the seat control unit 3 performs the walk-in function when the ID information outputted by the operation of the portable-device side request switch 21. Therefore, the user can operate the portable-device side request switch 21 to perform the unlock of the door locks and the walk-in actuation, holding his or her luggage or child. It can improve its user-friendliness.

While there have been particularly shown and described with reference to preferred embodiments thereof, it will be understood that various modifications may be made therein, and it is intended to cover in the appended claims all such modifications as fall within the true spirit and scope of the invention.

For example, in the above-mentioned embodiments, the front seats are changed in their position state so that their seat backs are reclined forward and the entire seats are moved forward, and in addition to this actuation, a rear seat may be moved and/or other actuation may be added.

A request switch may be arranged at other portion of a motor vehicle or other device, being not limited on the driver's-seat side door, the front-passenger's-seat side door, and the portable device. The request switch may be a touch sensor, for example, a sensor for inputting when a user touches a door knob, instead of a press switch.

In the first to fourth embodiments, the authentication is made and this operation (a long-time pressing operation), of keeping pressing the request switch beyond the predetermined time, causes the walk-in actuation when the request switch is operated, while the actuation may be performed not by using the request switch. For example, authorization may be made without a request switch to allow wireless communication between the portable device and the keyless control unit, and the walk-in actuation may be performed when the door locks are unlocked. In this case, when the doors are opened, the walk-in actuation has been ended, so that a passenger can surely and quickly get in a rear seat side compartment.

Further, a motor vehicle is not limited to two door type motor vehicle. A front seat in the invention is not limited to a driver's seat and a front passenger's seat, and includes a second row seat having the walk-in function in a motor vehicle with three row seats, so that the a passenger can easily get in a third-row-seat side compartment when the second row seat is actuated to perform the walk-in function.

Further, some of functions of the keyless control unit 1 and the seat control 3 may be exchanged between the control units or contained in one of the control units different from those of the embodiments. In addition, the control units may be integrated as one control unit.

The entire contents of Japanese Patent Application No. 2005-273697 filed Oct. 6, 2005 are incorporated herein by reference.

What is claimed is:

1. seat system adapted for a motor vehicle comprising:
a portable device that is taken along with a user and is capable of sending at least identification information;
a keyless control unit that is installed on a motor vehicle to communicate with the portable device for locking and unlocking door lock when authorization is judged based on the identification information;
a front seat;
an actuator for changing position state of the front seat; and
a seat control unit that is installed on the motor vehicle to perform a walk-in function for changing the position state of the front seat according to an operation of the portable device so that a passenger can easily get in a rear seat compartment, when the authorization is made.

2. The seat system adapted for a motor vehicle according to claim 1, further comprising:
a request switch provided on the portable device for executing an authentication process, wherein
the seat control unit performs the walk-in function according to the operation of the request switch when the authorization is made.

3. The seat system adapted for a motor vehicle according to claim 1, further comprising:
a request switch provided on a driver's-seat side of the motor vehicle for executing an authentication process, wherein
the seat control unit performs the walk-in function of a front passenger's seat according to the operation of the request switch when the authorization is made.

4. The seat system adapted for a motor vehicle according to claim 1, further comprising:
a request switch provided on a driver's-seat side of the motor vehicle for executing an authentication process, and
a walk-in function setting switch for setting one, to be actuated, of the walk-in functions of a driver's seat and a front passenger's seat, wherein
the seat control unit actuates the walk-in function of a seat, set by the walk-in function setting switch, according to an operation of the request switch when the authorization is made.

5. The seat system adapted for a motor vehicle according to claim 1, further comprising:
a request switch provided on a driver's-seat side of the motor vehicle for executing an authentication process, and
a judging means for judging, based on an operation of the request switch and a state of the motor vehicle, which of the walk-in functions of a driver's seat and a front passenger's seat is performed, wherein
the seat control unit actuates the walk-in function of a seat, selected based on a judgment result the judging means, according to an operation of the request switch when the auto a request switch provided on a driver's-seat side of the motor vehicle for executing an authentication process, and authorization is made.
